(19) United States
(12) Patent Application Publication
(10) Pub. No.: US 2013/0156300 A1
(43) Pub. Date: Jun. 20, 2013

(54) Multi-Class Classification Method

(71) Applicants: Fatih Porikli, Watertown, MA (US); Yuejie Chi, Durham, NC (US)

(72) Inventors: Fatih Porikli, Watertown, MA (US); Yuejie Chi, Durham, NC (US)

(21) Appl. No.: 13/330,905

(22) Filed: Dec. 20, 2011

(51) Int. Cl. G06K 9/62

(52) U.S. Cl. 382/159

(57) ABSTRACT

A test sample is classified by determining a nearest subspace residual from subspaces learned from multiple different classes of training samples, and a collaborative residual from a collaborative representation of a dictionary constructed from all of the test samples. The residuals are used to determine a regularized residual. The subspaces, the dictionary and the regularized residual are inputted into a classifier, wherein the classifier includes a collaborative representation classifier and a nearest subspace classifier, and a label is assigned to the test sample using the classifier, and wherein the regularization parameter balances a trade-off between the collaborative representation classifier the nearest subspace classifier.

### FIELD OF THE INVENTION

This invention relates generally to multi-class classification, and more particularly to jointly using a collaborative representation classifier and a nearest subspace classifier collaborative representation classifier.

### BACKGROUND OF THE INVENTION

Multi-class classification assigns one of several class labels to a test sample. Advances in sparse representations (SR) use a sparsity pattern in the representation to increase the classification performance. In one application, the classification can be used for recognizing faces in images.

For example, an unknown test face image can be recognized using training face images of the same person and other known faces. The test face image has a sparse representation in a dictionary spanned by all training images from all persons.

By reconstructing the sparse representation using basis pursuit (BP), or orthogonal matching pursuit (OMP), and combining this with a sparse representation based classifier (SRC), accuracy of the classifier can be improved.

The complexity of acquiring the sparse representation using the sparsity inducing l₁ norm minimization instead of the sparsity enforcing l₀ norm approach is prohibitively high for a large number of training samples. Therefore, some methods use Gabor frame based sparse representation, a learned dictionary instead of the entire training set for dictionary, or hashing to reduce the complexity.

It is questionable whether the SR is necessary. In fact, the test sample has an infinite number of possible representations using the dictionary constructed from all training samples, all of which have taken advantages of the collective power among different classes. Therefore, they are called collaborative representation. The sparse representation is one example of collaborative representation.

In other words, all training samples collaboratively form a representation for the test sample, and the test sample is decomposed into a sum of collaborative components, each coming from a different subspace defined by a class.

It can be argued that not the sparse representation, but the collaborative representation is crucial. Using a different collaboration representation for the SRC, such as a regularized least-square (LS) representation, can also achieve similar performance with much lower complexity.

### SUMMARY OF THE INVENTION

With collaborative representation, all training samples from all classes can be used to construct a dictionary to benefit multi-class classification performance.

The embodiments of the invention use the collaborative representation to decompose a multi-class classification problem by finding and inputting the collaborative representation into the multi-class classifier.

Using the collaborative representation obtained from all training samples in the dictionary, the test sample is first decomposed into a sum of components, each coming from a separate class, enabling us to determine an inter-class residual.

In parallel, all intra-class residuals are measured by projecting the test sample directly onto the subspace spanned by the training samples of each class. A decision function seeks the optimal combination of these residuals.

Thus, our multi-class classifier provides a balance between a Nearest-Subspace Classifier (NSC) and the Collaborative Representation Classifier (CRC). NSC classifies a sample to the class with a minimal distance between the test sample and its principal projection. CRC classifies a sample to the class with the minimal distance between the sample reconstruction using the collaborative representation and its projection within the class.

The SRC and the NSC become special cases under different regularization parameters.

Classification performance can be improved by optimally tuning the regularization parameter, which is done at almost no extra computational cost.

### BRIEF DESCRIPTION OF THE DRAWINGS

FIG. 1 is a flow diagram of a procedure for tuning a regularization parameters for a Collaborative Representation Optimized Classifier according to embodiments of the invention; and

FIG. 2 is a flow diagram of a method to perform multi-class classification according using the regularization parameter to embodiments of the invention.

### DETAILED DESCRIPTION OF THE PREFERRED EMBODIMENT

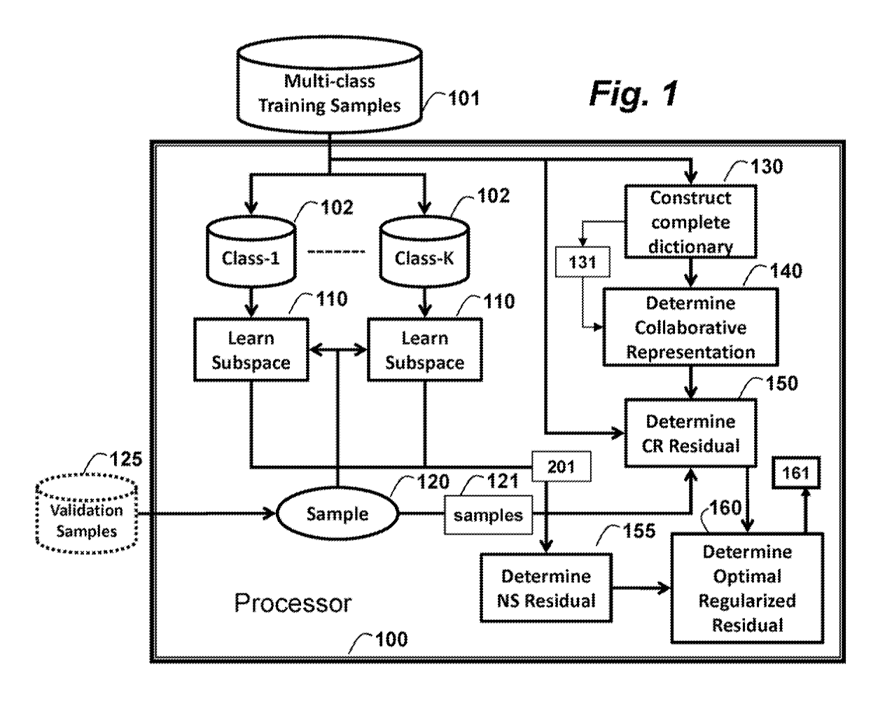

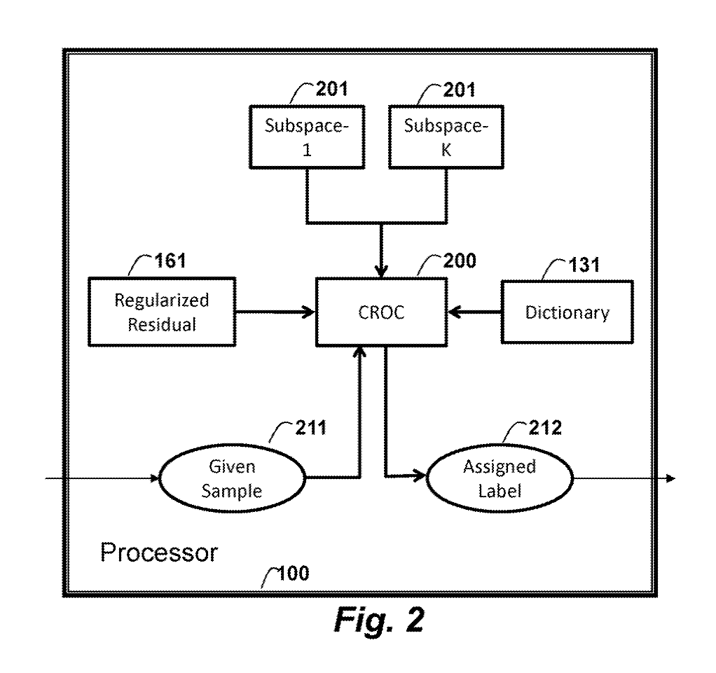

FIG. 1 shows a procedure for tuning a regularization parameters for a Collaborative Representation Optimized Classifier (CROC) according to embodiments of our invention. The regularization parameter is used to perform multi-class classification as shown in FIG. 2.

Multi-class training samples 101 are partitioned into a set of K classes 102. The training samples are labeled. A subspace 201 is learned 110 for each class.

Multi-class validation samples 125 can also be sampled 120, and integrated with the learned subspaces.

A dictionary 131 is also constructed 130 from the multi-class training samples, and a collaborative representation is determined from the dictionary. A collaborative residual is determined 150 from the collaborative representation and the training samples 121.

A nearest subspace (NS) residual is determined 155 from the learned subspaces.

Then, the optimal regularized residual 161 is determined 160 from the collaborative and NS residuals.

FIG. 2 shows how the regularized residual is used to perform our multi-class classification.

Inputs to our CROC 200 are the subspaces 201, the dictionary 131 and the regularized residual 161. Regularization generalizes the classifier to unknown data.

For classification, an unknown sample 211 is assigned 212 a label using the CROC, which includes a collaborative representation classifier and a nearest subspace classifier.

The details of the procedure and the method are now described in greater detail. It is understood that the above steps can be performed in a processor 100 connected to a memory and input/output interfaces as known in the art.

Multi-Class Classification

For K classes 102, nᵢ training samples 101 of the i^{th} class are stacked in a matrix as

Aᵢ=[a_{i,1}, . . . , a_{i,n}_{ᵢ}] ∈ [symbol] ^{m×n}^{ᵢ},

where a_{i,j} ∈ [symbol] ^{m} is the j^{th} training sample of dimension m from the i^{th} class.

By concatenating all training samples, we construct a dictionary 131

A=[A₁, A₂, . . . , A_{K}] ∈ [symbol] ^{m×n},

where n=Σᵢ₌₁^{K}nᵢ.

We are interested in classifying the test sample 211 y ∈ [symbol] ^{m}, given the labeled training samples in the matrix (dictionary) A.

According to embodiments of the invention, the multi-class classification problem is explicitly decomposed into two parts, namely determining 140 a collaborative representation of the test sample using the dictionary, and inputting the collaborative representation into the classifier to assign 212 a class label to the test sample.

Collaborative Representation

In an example face recognition application, images of a face of the same person under various illuminations and expressions approximately span a low-dimensional linear subspace in [symbol] ^{m}. Assume the test sample y can be represented as a superposition of training images in the dictionary A, given a linear model

y=Ax, (1)

where x is the collaborative representation of the test sample by exploring all training samples as a dictionary.

A least-squares (LS) solution of Eqn. (1) is

$${x}_{LS} = arg {min}_{x} {‖ y - Ax ‖}_{2} = {A}^{†} y , \qquad ( 2 )$$

when A is over-determined, i.e., the dimension of the samples is much larger than the number of training samples, A^{†}=(A^{T}A)⁻¹A^{T}, and when A is under-determined,

A^{†}=A^{T}(AA^{T})⁻¹,

where † indicates Moore-Penrose pseudoinverse. The Moore-Penrose pseudoinverse of a matrix is a generalization of the inverse matrix.

We are motivated by the theory of compressive sensing when it is impossible to acquire the complete test sample, but only a partial observation of the test sample is available via linear measurements and one is interested in classification on the incomplete information. This can be viewed equivalently as linear feature extraction.

We refer the collection of these linear measurements as a partial image because the collection is not necessarily defined by a conventional image format. For example, the collection of the linear measurements, i.e., the partial image, might be a small vector or a set of numbers. Alternatively, the partial image can be an image where only the values of certain pixels are known. In comparison, all the pixel values are known for the complete image.

We use linear features, i.e., the extracted features can be expressed in terms of linear transformation:

\tilde{y}=Ry; Ã=RA, (3)

where R is the linear transformation.

Determining 140 the collaborative representation of the test sample is a solution to the under-determined equation:

\tilde{y}=Ãx. (4)

Two choices for the solution are:
(i) a sparse solution x_{L1} by minimizing the l₁ norm of the collaborative representation:

$${x}_{L 1} = arg {min}_{x} {‖ x ‖}_{1} s . t . \tilde{y} = \tilde{A} x . \qquad ( 5 )$$

or the relaxed version

$${x}_{L 1} = arg {min}_{x} {‖ x ‖}_{1} s . t . {‖ \tilde{y} - \tilde{A} x ‖}_{2} \leq ɛ . \qquad ( 6 )$$

The l₁ norm constraint uses a minimal number of examples to represent y, as it is beneficial in certain cases, but the complexity is also greatly increased,
(ii) a least-norm solution x_{L2} by minimizing the l₂ norm of the collaborative representation:

$${x}_{L 2} = arg {min}_{x} {‖ x ‖}_{2} s . t . \tilde{y} = \tilde{A} x , \qquad ( 7 )$$

which gives

$${x}_{L 2} = {\tilde{A}}^{†} \tilde{y} .$$

These two solutions can also be determined for a complete image model. To summarize, we mainly consider three different collaborative representations for our embodiments, the LS solution using the complete image, and a sparse solution, and a least-norm solution using linear features (partial image). All the three representations x_{LS}, x_{L1} and x_{L2} represent the test image y using all the examples, instead of those within one class, which is why it is called “collaborative representation,” because different classes “collaborate” in the process of forming the representation.

In particular, the representations x_{L1}, x_{LS} and x_{L2} can use the same multi-class classifier (namely, a sparse representation based classification (SRC) for face recognition. However, the computation of x_{LS} and x_{L2} is much easier than x_{L1}. We do not require a particularly collaborative representation, but describe a common trade-off in the performance of our classifier, no matter which one is used.

Sparse Representation Classifier (SRC)

We now describe the sparse representation classifier. Although the name indicates it is for sparse representation, it can also be used for any collaborative representation as an input. We use this name for consistence.

The SRC uses the collaborative representation x=[x₁, . . . , x_{K}] of the test sample y as an input, where xᵢ is the part of the coefficient corresponding to the i^{th} class in the coefficient x. The SRC identifies the test image with the i^{th} class if the residual

rᵢ^{SR}=∥y−Aᵢxᵢ∥₂² (8)

is smallest for the i^{th} class.

If the test image can be sparse represented by all training images as x=[0, . . . , xᵢ, . . . , 0], such that the test image can be represented by using only training samples within the correct class, then the residual for the correct class is zero, while the residual from other classes is the norm of the test image, resulting in maximal discriminative power for classification.

The SRC checks for the angle, i.e., the dot product of the normalized vector representations, between the test image and the partial signal represented by the coefficient on the correct class, which should be small, and also the angle between the partial signal represented by the coefficient on the correct class and that on the rest classes, which should be large.

In addition, we describe a quantitative view and generalize the SRC to a regularization of classifiers, where the NSC and the SRC correspond to two special cases of a general framework.

Regularizing the Classifier

We now describe the nearest subspace classifier (NSC), which classifies a sample to the class with the minimal distance between the test sample and its principal projection. Then, we describe the collaborative representation based classifier (CRC), which classifies a sample to the class with the minimal distance between the sample reconstruction using the collaborative representation and its projection within the class. Finally, we describe the optimal collaborative classifier (CROC), which is a regularized and superset of classifiers from the NSC and the CRC, and the above SRC can be viewed as a particular instance, i.e., a specific version that uses blends the NSC and CRC in a predetermined way.

Nearest Subspace Classifier (NSC)

The NSC, assigns the test image y to the i^{th} class if the distance, or the projection residual rᵢ^{NS} from y to the subspace spanned by the i^{th} training images the smallest among all classes, i.e.,

$$i = arg {min}_{i} {r}_{i}^{NS} .$$

Moreover, rᵢ^{NS} is given as

$$\begin{matrix}{r}_{i}^{NS} = {min}_{{x}_{i}} {‖ y - {A}_{i} {x}_{i} ‖}_{2}^{2} \\ = {‖ y - {A}_{i} {x}_{i}^{LS} ‖}_{2}^{2} & ( 9 ) \\ = {‖ ( I - {A}_{i} {A}_{i}^{†} ) y ‖}_{2}^{2} . i = 1 , … , K , & ( 10 )\end{matrix}$$

where the least-squares solution within the ith class is xᵢ^{LS}=Aᵢ^{†}y.

The above formulation of the NSC is used when the training samples per class is small so that the samples do span a subspace. This the usual case in face recognition. When the number of training samples is large, such as in fingerprint recognition, a principal subspace Bᵢ for each Aᵢ is usually extracted using principal component analysis (PCA) first, then rᵢ^{NS} is determined as

$${r}_{i}^{NS} = {min}_{{x}_{i}} {‖ y - {B}_{i} {x}_{i} ‖}_{2}^{2} , i = 1 , … , K . \qquad ( 11 )$$

The NSC does not require the collaborative representation of the test sample, and rᵢ^{NS} measures the similarity between the test image and each class without considering the similarities between classes.

Collaborative Representation Based Classifier (CRC)

We present the collaborative representation classifier (CRC), which assigns a test sample to the class with the minimal distance rᵢ^{CR} between the reconstruction using the collaborative representation corresponding to the i^{th} class, and its least-squares projection within the class, where

rᵢ^{CR}=∥Aᵢ(xᵢ−xᵢ^{LS})∥₂². (12)

The residual measures the difference between signal representations obtained from using only the intra-class information and the one using the inter-class information obtained from the collaborative representation.

If the test image can be sparse represented by all training images, then the residual for the correct class is zero, while the residual from other classes is the projection of the test image, maintaining similar discriminative power as the SRC. Furthermore, when Aᵢ is over-complete, Eqn. (12) is equivalent to Eqn. (8). That is, when Aᵢ is over-determined rᵢ^{CR}=∥Aᵢ(xᵢ−Aᵢ⁺)y∥₂² and when Aᵢ is under-determined rᵢ^{CR}=∥y−Aᵢxᵢ∥₂².

Regularizing Between NSC and CRC

Given the NSC and the CRC, which use the intra-class residual and the inter-class residual respectively, we describe the Collaborative Representation Optimized Classifier (CROC) classifier to balance a trade-off between these two classifiers, where the CROC regularized residual for each class is

rᵢ(λ)=rᵢ^{NS}+λrᵢ^{CR}, (13)

where a scalar λ≧0 is a regularization parameter. The test sample is then assigned the label of the class that has the minimal regularized residual. When λ=0, it is equivalent to the NSC; and when λ=+∞, it is equivalent to the CRC.

We now describe the SRC that corresponds to a particular CROC in two cases: when Aᵢ is over-complete and training samples are abundant. Because the CROC is equivalent to the CRC and SRC in this case, the CROC corresponds to selecting λ=+∞, and when Aᵢ is over-determined. The SRC is equivalent to the CROC classifier when λ=1. The residual of each class for SRC Eqn. (8) is:

$$\begin{matrix}{r}_{i}^{SR} = {‖ y - {A}_{i} {x}_{i} ‖}_{2}^{2} \\ = {‖ ( I - {A}_{i} {A}_{i}^{†} ) y + {A}_{i} ( {A}_{i}^{†} y - {x}_{i} ) ‖}_{2}^{2} & ( 14 ) \\ = {‖ ( I - {A}_{i} {A}_{i}^{†} ) y ‖}_{2}^{2} + {‖ {A}_{i} ( {A}_{i}^{†} y - {x}_{i} ) ‖}_{2}^{2} & ( 15 ) \\ = {r}_{i}^{NS} + {r}_{i}^{CR} , & ( 16 )\end{matrix}$$

where Eqn. (15) follows from

(I−AᵢAᵢ^{†})Aᵢ=0.

Alternatively, we can represent the CROC regularized residual as

rᵢ(λ)=λrᵢ^{NS}+(1−λ)rᵢ^{SR}. (17)

Clearly, the conventional SRC only considers one possible trade-off between the NSC and the CRC by weighting the two residual terms equally. Our invention uses a better regularized residual, where the regularized residual varies independently, to outperform the SRC regardless of which collaborative representation is selected to represent the test sample.

We rewrite an error of the regularized for the CROC as

$$\begin{matrix}{r}_{i} ( λ ) = {‖ y - {A}_{i} {x}_{i}^{LS} + \sqrt{λ} {A}_{i} ( {x}_{i}^{LS} - {x}_{i} ) ‖}_{2}^{2} \\ = {‖ y - {A}_{i} [ ( 1 - \sqrt{λ} ) {x}_{i}^{LS} + \sqrt{λ} {x}_{i} ] ‖}_{2}^{2} \\ = {‖ y - {A}_{i} {\tilde{x}}_{i} ‖}_{2}^{2}\end{matrix}$$

where

\tilde{x}ᵢ=(1−\sqrt{λ})xᵢ^{LS}+\sqrt{λ}xᵢ. (i)

If we write

\tilde{x}=[\tilde{x}₁, . . . , \tilde{x}_{K}]=(1−\sqrt{λ})x^{LS}+\sqrt{λ}x, (i)

where x is the input collaborative representation, and

x^{LS}=[x₁^{LS}, . . . , x_{K}^{LS}] (ii)

is “combined representation” by the least-square solution within each class, then $ \tilde{x} can be viewed as a different collaborative representation induced by x, and the CROC is equivalent to the SRC with a different collaborative representation as the input.

Classification with Compressive Sensing Measurements

Compressive sensing (CS) reconstructs a signal (image) from only a small number of linear measurements given the signal can be sparsely or approximately sparsely represented in a pre-defined basis, such as the wavelet basis or discrete cosine transform (DCT) basis. It is of increasing interests to develop multi-class classification procedures that can achieve high classification accuracy without acquiring the complete image.

This can be viewed complementarily as a linear feature extraction technique, when the complete image is available. If the complete image is not available, the residual is determined by replacing y with \tilde{y}, and replacing Aᵢ with Ãᵢ.

Determining the Regularization Parameter

The optimal value of the scalar regularization parameter λ can be determined by cross-validation. After both inter-class residual rᵢ^{CR} and intra-class residual rᵢ^{NS} are for the training samples, the overall error scores, using different values of the regularization parameter, is determined. This incurs almost no additional cost as the intra- and inter-class residuals are already determined.

Instead of the training samples, the separate validation samples 125 can also be used.

The complexity of the testing stage is proportional to the norm of the selected collaborative representation, e.g., LS.

Our classifier can also be considered as an elegant ensemble approach that does not require either explicit decision functions or complete observations (images).

### Effect of the Invention

The embodiments of the invention explicitly decompose a multi-class classification problem into two steps, namely determining the collaborative representation and inputting the collaborative representation in the multi-class classifier (CROC).

We focus on the second step and describe a novel regularized collaborative representation based classifier, where the NSC and the SRC are special cases on the whole regularization path.

The classification performance can be further improved by optimally tuning the regularization parameter at no extra computational cost, in particular when only a partial test sample, e.g., a test image, is available via CS measurements.

The novel multi-class classifier strikes a balance between the NSC, which a label to a test sample according to the class with the minimal distance between the test sample and its principal projection, and the CRC, which assigns the test sample to the class with the minimal distance between the sample reconstruction using the collaborative representation and its projection within the class.

Moreover, the SRC and the NSC become special cases under different regularized residuals. Classification performance can be further improved by optimally tuning the regularization parameter λ, which is done at almost no extra computational cost.

Although the invention has been described by way of examples of preferred embodiments, it is to be understood that various other adaptations and modifications can be made within the spirit and scope of the invention. Therefore, it is the object of the appended claims to cover all such variations and modifications as come within the true spirit and scope of the invention.

We claim:

1. A method for classifying a test sample, comprising the steps of:
determining a nearest subspace residual from subspaces learned from multiple different classes of training samples;
determining a collaborative residual from a collaborative representation of a dictionary constructed from all of the training samples;
determining regularized residuals using a regularization parameter, wherein the regularization parameter balances a trade-off between the collaborative representation residual and the nearest subspace residual; and,
inputting the regularized residuals into a classifier that assigns a label to the test sample.

2. The method of claim 1, wherein the subspace residual is an intra-class residual, and the collaborative residual is an inter-class residual.

3. The method of claim 1, wherein the nearest-neighbor classifier assigns the label of a class with a smallest total regularized residual.

4. The method of claim 1, wherein the classifier is a combination of multiple binary classifiers whose inputs are the regularization parameter, the collaborative representation residuals, and the nearest subspace residuals of all the classes.

5. The method of claim 1, wherein the regularized residual is
rᵢ(λ)=rᵢ^{NS}+λrᵢ^{CR},
where a scalar λ≧0 is the regularization parameter, rᵢ^{NS} is the nearest subspace residual, and rᵢ^{CR} is the collaborative representation residual.

6. The method of claim 1, wherein the regularization parameter λ is determined by cross-validation.

7. The method of claim 1, further comprising:
stacking the nᵢ training samples of the i^{th} class in a matrix as
Aᵢ=[a_{i,1}, . . . , a_{i,n}_{ᵢ}],
where a_{i,j} is the j^{th} training sample of dimension m from the i^{th} class.
concatenating all the training samples in the matrices to construct the dictionary
A=[A₁, A₂, . . . , A_{K}],
where n=Σᵢ₌₁^{K}nᵢ.

8. The method of claim 7, further comprising:
determining a collaborative representation of the test sample using the dictionary.

9. The method of claim 8, wherein the test sample is y, and a linear model is y=Ax, and where x is the collaborative representation.

10. The method of claim 1, wherein the collaborative representation residual is
rᵢ^{CR}=∥Aᵢ(xᵢ−xᵢ^{LS})∥₂²
for the i^{th} class where y is the test sample, xᵢ^{LS} is a least-squares projection within the class for the dictionary A.

11. The method of claim 10, wherein the collaborative representation residual is
rᵢ^{CR}=∥Aᵢ(xᵢ−Aᵢ⁺)y∥₂²
if Aᵢ is over-determined, where A⁺=(A^{T}A)⁻¹A^{T} is a pseudo-inverse operator.

12. The method of claim 10, wherein the collaborative representation residual is
rᵢ^{CR}=∥y−Aᵢxᵢ∥₂²
if Aᵢ is under-determined.

13. The method of claim 1, wherein the nearest subspace residual is
$${r}_{i}^{NS} = {min}_{{x}_{i}} {‖ y - {A}_{i} {x}_{i} ‖}_{2}^{2} .$$

14. The method of claim 17, further comprising:
extracting principal subspace Bᵢ for each Aᵢ using principal component analysis and
$${r}_{i}^{NS} = {min}_{{x}_{i}} {‖ y - {B}_{i} {x}_{i} ‖}_{2}^{2} .$$

15. A method for classifying a test sample, comprising the steps of:
determining a nearest subspace residual from subspaces learned from multiple different classes of training samples;
determining a collaborative residual from a sparse representation of a dictionary constructed from all of the training samples;
determining regularized residuals using a regularization parameter, wherein the regularization parameter balances a trade-off between the sparse representation residual and the nearest subspace residual; and,
inputting the regularized residuals into a classifier that assigns a label to the test sample.

16. The method of claim 18, wherein the regularized residual is
rᵢ(λ)=λrᵢ^{NS}+(1−λ)rᵢ^{SR}.
where a scalar λ≧0 is a regularization parameter.

17. The method of claim 19, wherein the sparse residual
rᵢ^{SR}=∥y−Aᵢxᵢ∥₂²,
is smallest for the i^{th} class.

18. The method of claim 19, wherein the sparse representation classifier uses a collaborative representation x=[x₁, . . . , x_{K}] of the test sample y as an input, where xᵢ is a part of coefficient corresponding to the i^{th} class in the coefficient x.

19. The method of claim 19, wherein the sparse represented by all the training images is x=[0, . . . , xᵢ, . . . , 0].

20. The method of claim 1, further replacing y with \tilde{y}, and replacing Aᵢ with Ãᵢ for a sparse test image.

21. The method of claim 1, wherein the test sample is an image of an unknown face, and the training samples are images of known faces.
